(19) United States
(12) Patent Application Publication
(10) Pub. No.: US 2002/0029645 A1
(43) Pub. Date: Mar. 14, 2002

(54) Combined detent and monitored position sensor for transmission shift member

(75) Inventors: Graeme Andrew Jackson, Bolton (GB); David Brockelbank, Morecambe (GB)

Correspondence Address: Howard D. Gordon, Eaton Corporation, Eaton Center, 1111 Superior Avenue, Cleveland, OH, 44114-2584, US

(73) Assignee: EATON CORPORATION, Cleveland, OH (US)

(21) Appl. No.: 09/846,662

(22) Filed: May 1, 2001

(30) Foreign Application Priority Data
May 5, 2000 (GB) 0010778.9

(51) Int. Cl. F16H 63/42

(52) U.S. Cl. 74/335

(57) ABSTRACT

A combination (10) utilizing a single detent plunger (22) provides in-gear and in-neutral detent functions and an in-monitored-position (such as in-neutral signal (N)) function. A shift member (12,60) is provided with in-gear detent grooves (32,34) and an in-neutral detent groove (30) having different depths (36≠38).

### BACKGROUND OF THE INVENTION

### FIELD OF THE INVENTION

The present invention relates to in-gear and/or in-neutral detent mechanisms and in-monitored-transmission-ratio (such as neutral) sensors. In particular, the present invention relates to an assembly utilizing a single detent plunger to provide the functions of an in-gear and/or in-neutral detent and an in-monitored-transmission-ratio position sensor.

### DESCRIPTION OF THE PRIOR ART

Transmissions utilizing shift members, such as parallel shift rods or a single shift shaft, which are axially movable to in-gear and in-neutral positions, are well known in the prior art, as may be seen by reference to U.S. Pats. No. 5,737,969; 5,743,143; 4,974,468; 5,281,902; 4,920,815 and 5,481,170, the disclosures of which are incorporated herein by reference. It is also well known to use a rotatable cross-shaft having in-gear and in-neutral rotational positions to shift a transmission (see U.S. Pat. No. 5,471,893, the disclosure of which is incorporated herein by reference).

The prior art devices typically utilized separate detent and neutral and/or other monitored ratio condition (such as reverse) sensing devices, thereby increasing space requirements, part requirements, expense and assembly time.

### SUMMARY OF INVENTION

In accordance with the present invention, the drawbacks of the prior art are minimized by providing an assembly requiring a single detent plunger to provide all of the in-gear and/or in-neutral detent and in-monitored-ratio-position sensing functions.

The foregoing is accomplished by providing an axially or rotationally movable shaft having an in-the-monitored-ratio position and at least one other in-gear and/or in-neutral position with detent grooves or notches which will align with the detent plunger axis in the various positions of the shaft and having differing depths so that the axial position of the detent plunger with the shift member in the inmonitored-ratio axial or rotational position will differ from the axial position of the plunger with the shift member in a transient or in a different in-gear or in-neutral position. A position sensor is provided to sense at least one axial position of the plunger and to provide a signal indicative thereof. Preferably, the plunger, the sensor and the plunger biasing means are all contained in a plug-type assembly which is easily assembled to and removed from the housing as a one-piece subassembly.

Accordingly, it is an object of the present invention to provide an improved assembly utilizing a single detent plunger for providing an in-gear and/or in-neutral detent function and an in-monitored-ratio-condition-position signaling function for a transmission shift member.

This and other objects and advantages of the present invention will become apparent from a reading of the following description of the preferred embodiment taken in connection with the attached drawings.

### BRIEF DESCRIPTION OF THE DRAWINGS

FIG. 1 is an enlarged schematic illustration of one embodiment of the present invention.

FIG. 2 is an enlarged sectional view of a shift member having separate in-gear and in-neutral rotational positions and suitable for use in the present invention.

### DESCRIPTION OF THE PREFERRED EMBODIMENT

Change-gear transmissions utilizing shift members selectively axially or rotationally positioned into in-gear or in-neutral positions for shifting purposes are well known in the prior art. See aforementioned U.S. Pats. Nos. 5,737,969; 5,743,143; 5,481,170; 5,471,893; 4,974,468 and 4,920,815.

The prior art includes the use of in-gear and in-neutral detents, usually resiliently biased plungers or balls acting with grooves or slots in the shift member, to provide a positive feel of having achieved a desired position and to retain the shift member in position against the effects of shift lever whip or the like (see, for example, U.S. Pat. No. 5,758,543).

It is also well known to use sensors to sense when the transmission shifting devices are in a monitored-transmission-ratio-condition position, such as in a neutral position, a reverse position, a particular range position or the like, and to provide a signal indicative thereof. By way of example, it is important to have an accurate in-neutral signal for enabling the vehicle motor starter circuit and/or for various shift logics.

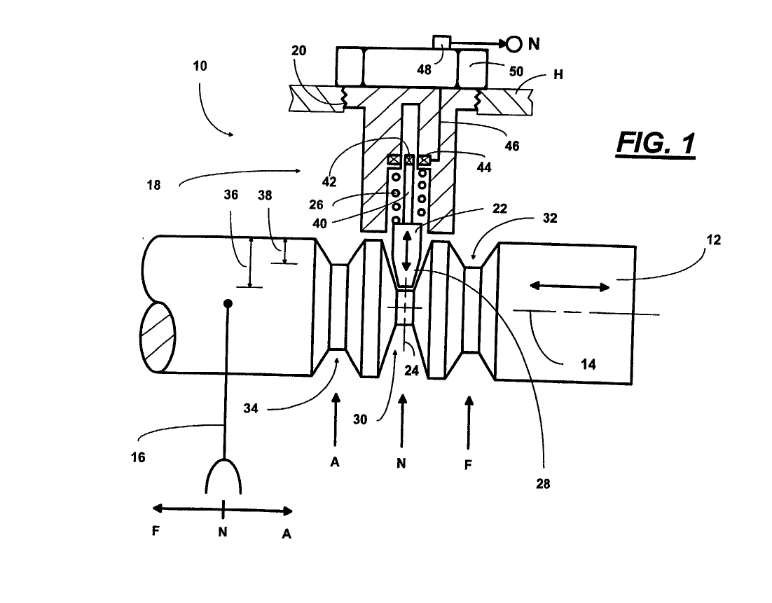

FIG. 1 is an exaggerated schematic view of the assembly or combination 10 of the present invention as utilized with a shift shaft 12 axially movable in a transmission housing H along a first axis 14 to a centered neutral position N and forward and aft to engaged positions F and A, respectively. Typically, one or more shift forks 16 will be movable with shaft 12 for selectively engaging and disengaging gears.

As may be seen from FIG. 1, centrifugal clutch 20 requires no external clutch actuator and is operated as function of the rotational speed (ES) of the engine. Centrifugal clutch 20 also requires no connections to operating linkages, command signal inputs, power electronics and/or compressed air and/or hydraulic conduits. The most economical application of the present invention is with a dry clutch, however, the present invention is also applicable to wet clutch technology.

Transmission system 10 further includes rotational speed sensors 32 for sensing engine rotational speed (ES), 34 for sensing input shaft rotational speed (IS), and 36 for sensing output shaft rotational speed (OS), and providing signals indicative thereof. A sensor 37 provides a signal THL indicative of throttle pedal position or of torque demand. The signal is usually a percentage (0% to 100%) of fuel throttle position. Engine 18 may be electronically controlled, including an electronic controller 38 communicating over an electronic data link (DL) operating under an industry standard protocol such as SAE J-1922, SAE J-1939, ISO 11898 or the like.

An X-Y shift actuator, which by way of example may be of the types illustrated in U.S. Pat. Nos.: 5,481,170; 5,281,902; 4,899,609; and 4,821,590, may be provided for automated or shift-by-wire shifting of the transmission main section and/or auxiliary section. Alternately, a manually operated shift lever 42 having a shift knob 44 thereon may be provided. Shift knob 44 may be of the type described in aforementioned U.S. Pat. No. 5,957,001. As is well known, shift lever 42 is manually manipulated in a known shift pattern for selective engagement and disengagement of various shift ratios. Shift Knob 44 may include an intent to shift switch 44A by which the vehicle operator will request automatic engine fueling control to relieve torque lock and allow a shift to transmission neutral. A shift selector 46 allows the vehicle driver to select a mode of operation and provides a signal GR_{T} indicative thereof.

In the example of FIG. 1, the plug assembly 18 includes a shaft 40 movable with plunger 22 which carries a material 42, such as, for example, magnetic or metallic material or the like, which can be sensed by proximity sensors 44 when the plunger 22 is in the axial position corresponding to shaft 12 being in the neutral position thereof. In the illustrated embodiment, a lead wire 46 extends from sensor 44 to a connector 48 located on the head 50 of the plug assembly 12. Sensor 44 will provide an in-neutral signal N when plunger 22 is fully received in in-neutral groove 30.

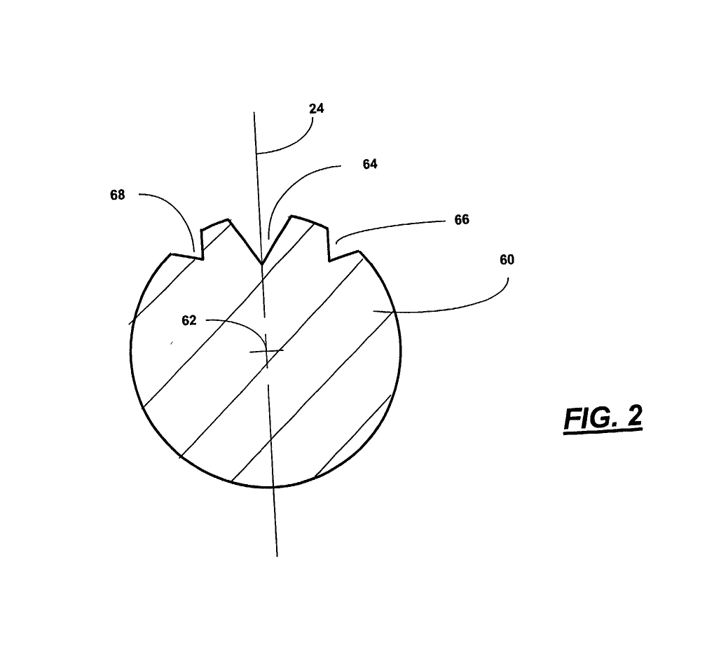

FIG. 2 illustrates a shaft 60, such as a cross-shaft or the like (see U.S. Pat. No. 5,471,893), having in-gear and in-neutral rotational positions. Shaft 60 may cooperate with a plug assembly 12 of the type discussed above in connection with FIG. 1 and is rotatable about an axis 62, which is intersected by second axis 24.

Shaft 60 is provided with a centered, deeper axially extending in-neutral groove 64 and shallower in-gear grooves 66 and 68 circumferentially displaced on each side thereof.

Accordingly, it may be seen that a new and improved assembly for providing in-gear and in-neutral detent functions and in-neutral sensing is provided.

Although the present invention has been described with a certain degree of particularity, it is understood that the description of the preferred embodiment is by way of example only and that numerous changes to form and detail are possible without departing from the spirit and scope of the invention as hereinafter claimed.

I claim:

1. A combination for providing an in-first-position detent function, an in-second-position detent function and an in-second-position signal for a transmission having a shift member (12,60) axially movable along or rotationally movable about a first axis (14,62) to at least one first position and to a second position, said combination comprising:
a single detent member (22) axially movable along a second axis (24) generally perpendicular to and intersecting said first axis, said detent member resiliently biased toward said first axis;
at least one in-first-position detent groove (66,68) having tapered sides and a first depth provided in said shift member, said in-first-position detent groove aligning with said second axis when said shaft is in a first position for receiving said detent member;
an in-second-position detent groove (64) having tapered sides and a second depth, provided in said shift member, said in-second-position groove aligning with said second axis when said shaft is in said second position for receiving said detent member, said first depth different from said second depth whereby said detent member will have a different axial position along said second axis when said shift member is in said first position than when said shift member is in said second position; and
a sensor for sensing when said detent member is in an axial position along said second axis corresponding to said shift member being in said second position and providing a signal indicative thereof.

2. The combination of claim 1 wherein said detent member is a plunger having a tapered tip.

3. The combination of claim 1 wherein said second depth is greater than said first depth.

4. The combination of claim 1 wherein said detent member (22) and said sensor are retained in a plug assembly (18) removably mounted to a transmission housing.

5. The combination of claim 1 wherein said first position is an in-gear position and said second position is an in-neutral position.

6. The combination of claim 1 wherein said first position is one of an in-gear position or an in-neutral postion and said second position is an in-reverse position.

7. A combination for providing an in-gear detent function, an in-neutral detent function and an in-neutral signal for a transmission having a shift member (12) axially movable along a first axis (14) to at least one in-gear position (F,A) and to an in-neutral position (N), said combination comprising:
a single detent member (22) axially movable along a second axis (24) generally perpendicular to and intersecting said first axis, said detent member resiliently biased toward said first axis;
at least one in-gear detent groove (32,34) having tapered sides and a first depth (38) provided in said shift member, said in-gear detent groove aligning with said second axis when said shaft is in an in-gear position for receiving said detent member;
an in-neutral detent groove (30) having tapered sides and a second depth (36), provided in said shift member, said in-neutral groove aligning with said second axis when said shaft is in said neutral position for receiving said detent member, said first depth different from said second depth (36≠38) whereby said detent member will have a different axial position along said second axis when said shift member is in an in-gear position than when said shift member is in said in-neutral position; and
a sensor (42,44) for sensing when said detent member is in an axial position along said second axis corresponding to said shift member being in the in-neutral position and providing a signal indicative thereof.

8. The transmission system of claim 7 wherein said transmission has one or more start ratios and said vehicle launch conditions are sensed if said transmission is engaged in a start ratio, vehicle speed is less than a reference value (OS<REF) and said master friction clutch is not engaged.

9. The transmission system of claim 7 wherein said system controller issues command signals to a shift actuator to cause shifting of said transmission, said controller causing upshifts only if an estimated engine speed at completion of an upshift into a target ratio (ES=OS*GR_{T}) exceeds a minimum reference value (ES>ES_{MIN}), said clutch has a driving member (60) rotatable with said engine output member and a driven member (62) rotatable with said input shaft, said clutch having a degree of engagement dependent upon the rotational speed of said driving member, said clutch being disengaged at engine idle speed, said clutch becoming incipiently engaged at an incipient engagement engine speed (ES_{IE}) greater than said engine idle speed (ES_{IE}>ES_{IDLE}), said clutch achieving a maximum engagement (74/76) at at least a lockup engine speed (ES_{LOCKUP}), said lockup engine speed greater than said incipient engagement engine speed (ES_{LOCKUP}>ES_{IE}), said clutch remaining at said maximum engagement at a disengagement engine speed (ES_{DISENGAGE}) less than said lockup engine speed and less than said minimum expected engine speed (ES_{MIN}) expected after an upshift (ES_{LOCKUP}>ES_{DISENGAGE} and ES_{MIN}>ES_{DISENGAGE}).

10. The transmission system of claim 9 wherein said system controller issues commands for transmission downshifts at an engine speed no less than a minimum downshift value (ES_{DSMIN}), said lockup engine speed greater than said minimum downshift value (ES_{MIN}>ES_{DSMIN}).

11. A vehicular automated transmission system comprising an electronically controlled internal combustion engine having an engine output member, an engine controller having at least one mode of operation for controlling engine fueling to control at least one of engine speed and engine torque, a multiple speed mechanical change gear transmission having an input shaft, a master friction clutch for drivingly connecting said engine output member to said input shaft, a manually operated throttle for manually requesting a degree of engine fueling, a system controller for receiving input signals including two or more of signals indicative of (i) engine speed,(ii) throttle position, (iii) engaged transmission ratio, (iv) input shaft speed, (v) vehicle speed and (vi) engine torque, and processing said signals according to logic rules to issue command output signals to system actuators including at least said engine controller, said system characterized by:
said master friction clutch being a centrifugally operated clutch, and
said system controller having at least one mode of operation wherein command signals are issued to said engine controller to control engine speed as a function of sensed engine speed.

12. The transmission system of claim 11 wherein said system controller includes logic rules for sensing vehicle launch conditions and said mode of operation is a vehicle launch mode of operation.

13. The transmission system of claim 12 wherein said transmission has one or more start ratios and said vehicle launch conditions are sensed if said transmission is engaged in a start ratio, vehicle speed is less than a reference value and said master friction clutch is not engaged.

14. A combination for providing an in-gear detent function, an in-neutral detent function and an in-neutral signal for a transmission having a shift member (60) rotationally movable about a first axis (62) to at least one in-gear position and to an in-neutral position, said combination comprising:
a single detent member (22) axially movable along a second axis (24) generally perpendicular to and intersecting said first axis, said detent member resiliently biased toward said first axis;
at least one in-gear detent groove (66,68) having tapered sides and a first depth provided in said shift member, said in-gear detent groove aligning with said second axis when said shaft is in an in-gear position for receiving said detent member;
an in-neutral detent groove (64) having tapered sides and a second depth, provided in said shift member, said in-neutral groove aligning with said second axis when said shaft is in said neutral position for receiving said detent member, said first depth different from said second depth whereby said detent member will have a different axial position along said second axis when said shift member is in an in-gear position than when said shift member is in said in-neutral position; and
a sensor for sensing when said detent member is in an axial position along said second axis corresponding to said shift member being in the in-neutral position and providing a signal (N) indicative thereof.

15. The combination of claim 14 wherein said detent member is a plunger having a tapered tip.

16. The combination of claim 14 wherein said second depth is greater than said first depth.

17. The combination of claim 14 wherein said detent member (22) and said sensor are retained in a plug assembly (18) removably mounted to a transmission housing.
